(19) United States
(12) Patent Application Publication
(10) Pub. No.: US 2012/0256905 A1
(43) Pub. Date: Oct. 11, 2012

(54) Segmented polarization modulators for stereoscopic projection

(75) Inventors: Rod Archer, Boulder, CO (US); Matt Cowan, Bloomingdale (CA); Michael G. Robinson, Boulder, CO (US); Gary D. Sharp, Boulder, CO (US)

(73) Assignee: REALD INC., Beverly Hills, CA (US)

(21) Appl. No.: 13/247,678

(22) Filed: Sep. 28, 2011

Related U.S. Application Data
(60) Provisional application No. 61/387,423, filed on Sep. 28, 2010.

(51) Int. Cl. G06T 15/00; G02F 1/1333; G09G 5/00; G02F 1/01

(52) U.S. Cl. 345/419; 359/238; 349/15; 359/246; 345/204

(57) ABSTRACT

A segmented polarizing device may be a polarizing modulator which may include strips of switching polarizer material. The switching polarizer material may be used to switch individual segments of the polarizing modulator at a time. In such devices, the polarizing modulator may be one or more liquid crystal cells (LC cell). As the LC modulation panel of a display refreshes an image from top to bottom, changing from left eye content to right eye content, the polarization of a corresponding part of a scrolling polarizing screen may change along with the display.

### CROSS-REFERENCE TO RELATED APPLICATIONS

This application claims priority to U.S. Provisional Patent Application Ser. No. 61/387423, filed Sep. 28, 2010, entitled “Segmented polarization modulators for stereoscopic projection,” the entirety of which is herein incorporated by reference.

### TECHNICAL FIELD

This disclosure generally relates to stereoscopic projection using polarized light, and more specifically relates to scrolling, segmented polarization modulation of light for stereoscopic projection in cinema, professional and home environments.

### BACKGROUND

In the last few years stereoscopic 3D projection has been accomplished with either digital light processing (DLP) imaging devices or with liquid crystal display/liquid crystal on silicon (respectively, LCD/LCOS) imaging devices. These devices work by projecting a sequence of substantially still images with each image projected for a short amount of time.

The DLP imaging devices can be switched substantially instantaneously and/or refreshed in as little as 200 microseconds. During the refresh time the display may be blanked for a period of time such that little light exits the projector, but the lamp may stay on. After the refresh, the display is unblanked, and the image of each frame may be projected for the remainder of the frame cycle, which is about 6.7 milliseconds in the case of 144 Hz projection for digital cinema. This allows the viewer to perceive a bright image of each frame. Left and right eye images are presented one after the other in a frame-sequential manner. A high frame rate is desired when projecting frame sequential 3D stereoscopic presentations so that the image retention characteristics of the human eye will perceive a continuous sequence of images in each eye. The high frame rate also places the left and right frames closer in time, which minimizes motion induced disparity errors. Each frame for each eye is presented twice or three times, which is known as double or triple flashing, in order to achieve the high frame rate needed for the perception of a continuous image in each eye.

For use with single DLP projectors during 3D stereoscopic presentations, RealD Inc. and other manufacturers offer various polarization switching modulators. By way of example, such polarization switching modulators are described in commonly-owned U.S. Pat. Nos. 4,792,850, 7,760,157, and 7,528,906, all of which are herein incorporated by reference in their entirety. When a left eye image is being projected, the polarization switching modulator is set to globally encode the presented polarization state to left eye polarity. During the blanking interval, while the projector is refreshing the imager with the opposite eye image, the polarization switching modulator globally switches to the right eye polarity. This sequence of switching polarity is continued as the projector alternately displays left and right eye images. The switching of the modulator is timed with a signal from the projector. Modulators such as the RealD polarization switching modulator, switch using a liquid crystal cell which has a very fast response time. Other known techniques for polarization switching use mechanical switching methods, such as a polarization wheel.

LCD/LCOS imaging devices may not be able to refresh as quickly as a DLP imaging device. The LCD/LCOS imaging device may employ most of the 6.7 millisecond frame exposure time mentioned above just to refresh the image for a single frame. If the lamp is blanked during the refresh time, there will not be very much of the total cycle time remaining The exposure time may not be sufficient to allow the viewer to perceive a good, bright image. Therefore, LCD/LCOS imagers have not been used for single projector frame sequential 3D presentation which is a serious disadvantage for LCD imaging technology. Instead, they are used in other creative ways such as in dual projector configurations where each projector runs at a normal 24 fps frame rate and each projector displays a separate eye view of the stereoscopic presentation. While this method works, it requires two projectors and is also disadvantaged by alignment and light balancing requirements.

### BRIEF SUMMARY

According to the present disclosure, a segmented polarization device for a projector may include a segmented polarization modulator. The segmented polarization modulator may be a plurality of polarization switching elements operable to selectively transform the state of polarization of incident modulated light. Also, the plurality of polarization switching elements may be strips of switching polarizer material that may be operable to switch individual segments of the segmented polarization modulator at a time. Each of the strips of switching polarizer material may be vertical strips and may be one or more liquid crystal cells. Additionally, the strips of switching polarizer material may be operable to refresh an image on a display from the top to the bottom which may change the display from a first mode to a second mode. Further, a first half of the display may be in the first mode and a second half of the display may be in the second mode.

Furthering the discussion of the strips of switching polarizer material, the strips may be operable to selectively transform the state of polarization of incident modulated light between substantially orthogonal polarization states. A voltage may also be applied to the segmented polarization modulator which may modulate the state of polarization of incident light. The strips of the switching polarizer material may be operable to switch polarization states, in which the switching may be timed to substantially coincide with a blank set of images lines that provide a dark period in a frame sequence. In one example, the plurality of polarization switching elements may be arranged in a quadrant pattern to form an optical window.

According to another aspect of the present disclosure, a method of stereoscopic projection may include operating a segmented polarization switch in a scrolling mode by sequentially switching individual polarization switching elements that may be substantially synchronized with a frame sequence of a display. The method of stereoscopic projection may also include inserting a blank set of image lines in the frame sequence which may include providing a dark period wherein the dark period may be a fraction of an image frame cycle time. Inserting the blank set of images lines in a frame sequence may also include blanking a small section of the display while a corresponding, aligned segment of a modulator switches polarization states. Additionally, the method may include timing the dark period to substantially coincide with the polarization state switching of each segment of a segmented modulator.

According to yet another aspect of the present disclosure, a method for providing a polarization device may include providing a segmented polarization modulator which may include a plurality of polarization switching elements operable to selectively transform the polarization state of incident light. The segmented polarization modulator may further include strips of switching polarization material operable to switch individual segments of a polarizing modulator. The method may also include refreshing an image on a display from the top to the bottom and changing the display from a first mode to a second mode, wherein refreshing the image may be coordinated with switching individual segments of the polarizing modulator. Additionally, the method may include selectively transforming the polarization state of incident light after the incident light passes through the segmented polarization modulator. Moreover, the method may further include transforming the state of polarization of the incident light passing through the segmented polarization modulator from a first polarization state to a second polarization state, in which the second polarization state may be substantially orthogonal to the first polarization state.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying figures, in which like reference numbers indicate similar parts, and in which:

FIG. 1 is a schematic diagram illustrating a top down view of a stereoscopic projector system projecting an image on a screen, in accordance with the present disclosure;

FIG. 2 is a schematic diagram illustrating one embodiment of a segmented polarization switch, in accordance with the present disclosure; and

FIG. 3 is a schematic diagram illustrating another embodiment of a segmented polarization switch, in accordance with the present disclosure.

### DETAILED DESCRIPTION

Generally, a segmented polarization device may include a segmented polarization modulator. The segmented polarization modulator may be a plurality of polarization switching elements operable to selectively transform the state of polarization of incident modulated light. Also, the plurality of polarization switching elements may be strips of switching polarizer material that may be operable to switch individual segments of the segmented polarization modulator at a time. Each of the strips of switching polarizer material may be vertical strips and may be one or more liquid crystal cells. Additionally, the strips of switching polarizer material may be operable to refresh an image on a display from the top to the bottom which may change the display from a first mode to a second mode. Further, a first half of the display may be in the first mode and a second half of the display may be in the second mode. The strips of switching polarizer material may be operable to selectively transform the state of polarization of incident modulated light between substantially orthogonal polarization states. A voltage may also be applied to the segmented polarization modulator which may modulate the state of polarization of incident light. The strips of the switching polarizer material may be operable to switch polarization states, in which the switching may be timed to substantially coincide with a blank set of images lines that provide a dark period in a frame sequence.

Additionally, a method of stereoscopic projection may include operating a segmented polarization switch in a scrolling mode by sequentially switching individual polarization switching elements that may be substantially synchronized with a frame sequence of a projector. The method of stereoscopic projection may also include inserting a blank set of image lines in the frame sequence which may include providing a dark period wherein the dark period may be a fraction of an image frame cycle time. Inserting the blank set of images lines in a frame sequence may also include blanking a small section of the display while a corresponding, aligned segment of a modulator switches polarization states. Additionally, the method may include timing the dark period to substantially coincide with the polarization state switching of each segment of a segmented modulator.

According to yet another aspect of the present disclosure, a method for providing a polarization device may include providing a segmented polarization modulator which may include a plurality of polarization switching elements operable to selectively transform the polarization state of incident light. The segmented polarization modulator may further include strips of switching polarization material operable to switch individual segments of a polarizing modulator. The method may also include refreshing an image on a display from the top to the bottom and changing the display from a first mode to a second mode, wherein refreshing the image may be coordinated with switching individual segments of the polarizing modulator. Additionally, the method may include selectively transforming the polarization state of incident light after the incident light passes through the segmented polarization modulator. Moreover, the method may further include transforming the state of polarization of the incident light passing through the segmented polarization modulator from a first polarization state to a second polarization state, in which the second polarization state may be substantially orthogonal to the first polarization state.

It should be noted that embodiments of the present disclosure may be used in a variety of optical systems and projection systems. The embodiment may include or work with a variety of projectors, projection systems, optical components, displays, microdisplays, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

### Segmented Polarization Modulators for Stereoscopic Projection

The present disclosure enables frame-sequential 3D projection with single projectors based on LCOS or LCD imaging devices.

Generally, cinema projectors based on LCOS imagers have projected both left and right images simultaneously. An imaging chip used in this system may have a 4096×2160 resolution and as a result, the two images are placed one over the other on the imaging chip at the same time. Because the projector spreads the lamp light over the entire imaging chip, this method results in significant light loss since not all pixels can be used to form the image. Also, this method requires a complex and expensive lens that splits the image in two halves, polarizes them oppositely from each other, and then joins the two images on the projection screen.

Additionally, known conference room projectors using LCD imagers may not have enough resolution to use the cinema approach of placing one image over the other. Thus, for a 3D presentation, they must be configured in a dual projector setup, where one projector displays the left eye content and the other projector displays the right eye content. The left and right eye content may present views for the left and right eye respectively. The dual projector setup involves extra cost of a second projector, synchronizing the signal to each projector and aligning the images on screen and balancing the light output and colors of both projectors. The teachings of the present disclosure may allow for a single projector to be used, eliminating extra cost and the synchronization and alignment operations. Thus, the ability to do single projector 3D with these projectors will be presented herein.

The teachings within the present disclosure described here may allow more pixels to be used, increasing the light output and resolution of the projected image. For example, on a 4K imaging device, the change from substantially simultaneous frame presentation to frame sequential presentation may increase the number of pixels used by 4× in the case of 2.39:1 aspect ratio content. A 4K imaging device may be an imaging device that produces an image that is approximately 4096 pixels wide. Additionally, although the horizontal resolution may remain substantially the same, the vertical resolution may vary with the aspect ratio. For example, a 2K image with a 16:9 aspect ratio may be 2048×1152 pixels while a 2K image with a 4:3 aspect ratio may be 2048×1536 pixels, while a 2K image with a 2.39:1 aspect ratio may be 2048×856 pixels. Increased usable light may indicate that a projector may provide a brighter image to the viewer, provide images to a larger screen, or both. Another key advantage is that the same single lens can be used for 3D as for 2D movies, eliminating the difficult lens change operation that is currently required. This disclosure will allow LCOS cinema projectors to display single projector 3D with much more light output, less cost and much easier installation and operation procedures. Continuing the example with 2.39:1 aspect ratio content, the light per eye may be approximately doubled when compared to the simultaneous frame presentation method.

The present disclosure provides a segmented scrolling polarizer for projectors such as, but not limited to, a LCD/LCOS projector. Although some of the embodiments discussed herein may refer specifically to a LCD/LCOS projector, this is for discussion purposes only and not of limitation. Embodiments disclosed herein may be implemented with any display, projector, or imaging device that refreshes images row by row. In one example, a scanned projector may be employed such as, but not limited to a scanned laser projector.

Further, although the term segmented scrolling polarizer may be used for discussion purposes, the segmented polarizer may benefit projectors that update a display on a scrolling or block basis. Moreover, additional schemes may be employed in which the update may scroll from the centerline up and down substantially simultaneously, or may update from left to right, right to left, from the center line to the left and right substantially simultaneously, and so on. In one example, a CRT display or any display that may refresh rows from top to bottom or vice versa may be employed with the segmented scrolling polarizer. Moreover, any type of self-illuminated projector may be employed with the segmented scrolling polarizer, including, but not limited to, CRT, scanned laser, OLED, any modulator based projector, and so on. A benefit of the technique provided in this disclosure may be accommodating slower refresh rates, as opposed to the refresh timing that existing polarization modulators can be used with. This may allow, for example, LCD/LCOS type imaging devices such as, but not limited to, light modulating panels, displays, microdisplays, projection systems such as, but not limited to OLED projection systems, optical systems and so on, to be used for single projector frame sequential stereoscopic projection.

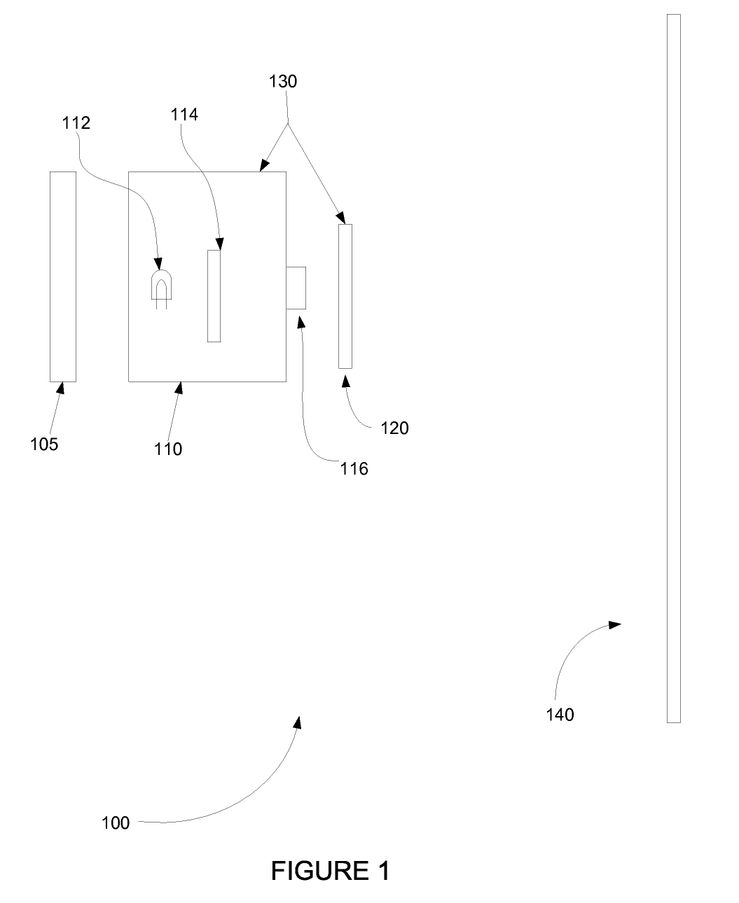

FIG. 1 is a schematic diagram illustrating a top down view of a stereoscopic projection system projecting an image on a screen. In FIG. 1, stereoscopic projection system 100 may include a projector 110 and a segmented polarization switch 120 projecting an image on a screen 140. Additionally, segmented polarization switch 120 may be located outside or inside the lens 116. In one example, the segmented polarization switch 120 may be located on the LCOS modulation panel 114 (not illustrated in FIG. 1). Source 105 provides image information to the projector 110. Source 105 may be a DVD, Bluray, computer, internet-enabled device, set-top box, or any other device that may provide electronic image content for presentation. Lamp 112 in projector 110 may illuminate LCD or LCOS modulation panel 114. It should be appreciated that various different projection engine technologies that incorporate LCD or LCOS modulation techniques may be employed, for example, reflective and transmissive modulation panels, and such various LCD/LCOS projection engines are not exhaustively discussed or illustrated for simplicity of the present description.

In common use a polarizing switch may be a single window which changes polarity uniformly across the optical window. A segmented polarization switch may utilize small segments which may change polarization state individually or in combination, allowing localized control of the polarity of the image for individual or multiple segments of the image. In one example, LC cells may be placed adjacent to or next to each other to form segments. In contrast, a standard polarization switch may switch the polarity of the entire window at the same time.

In another example, polarizing segments may substantially span the width of the optical window and may be arranged vertically. With that said, the polarizing strips may also be vertical strips that may be arranged horizontally to form an optical window. The polarizing segments may also be one or more LC cells. Further, each strip may be any type of polarizing switching material, including, but not limited to, an individual liquid crystal cell (LC cell), a pair of LC cells, pi-cells, FLC, TN cells, single or push pull TN or Pi-cells, STN, mechanical and so on.

Additionally, the optical window may include polarizing material in various configurations including, but not limited to, dividing the optical window into quadrants, radial segments, concentric patterns, or any other pattern and the strips may be switched sequentially for any configuration. These alternative arrangements may be employed with a display that may refresh an image in a non-vertical pattern. Furthermore, the polarizing material may be referred to herein as strips for discussion purposes only and not of limitation. The polarizing material may be any shape or configuration and arranged in various ways to produce any shape of an optical window.

Segmented polarization switch 120 may be placed in the light path in front of the projector lens 116 and may be operated in a scrolling mode of operation. The image from the projector may be properly aligned relative to the segments in the segmented polarization switch 120. Further, the segmented polarization switch 120 may be properly aligned by minimizing the amount of cross-talk between the left and right eye images. Each segment of the segmented polarization switch 120 may be switched to an opposite polarity as the image in the projector is updated, line by line from top to bottom. This may allow projectors with slow refresh rates to present frame sequential stereoscopic 3D content in cases where the refresh rate is too slow to work with a switching polarizer that switches the entire modulator at once.

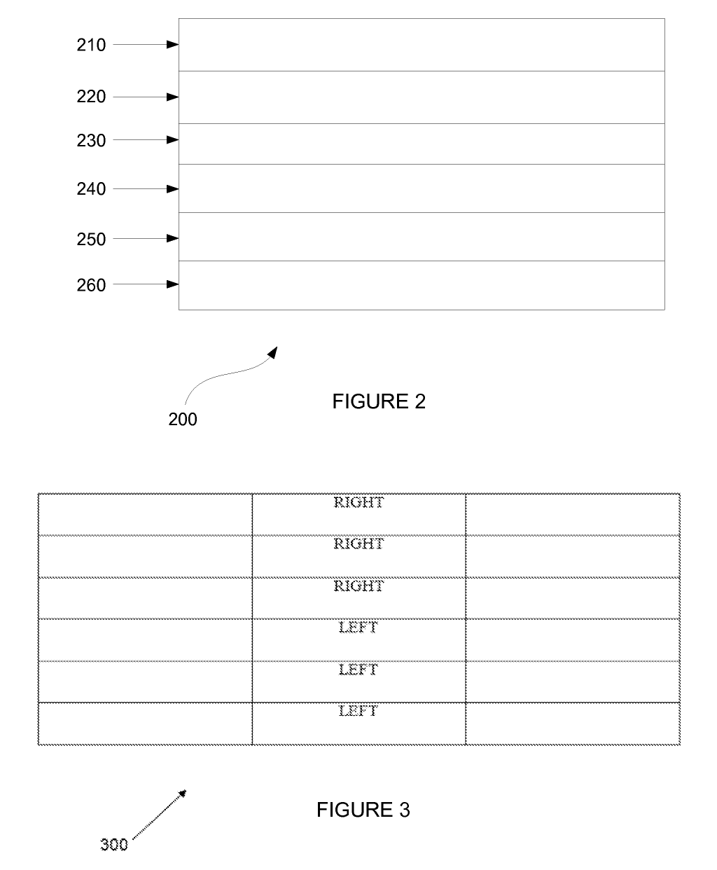

FIG. 2 is a schematic diagram illustrating another segmented polarization switch 200. Segmented polarization switch 200 includes polarization switching segments 210, 220, 230, 240, 250, 260, each of which may be controlled to transform the state of polarization according to the bias voltage applied. In one example, a bias voltage may be applied to each of the polarization switching segments starting with the polarization switching segment 210, then to polarization switching segment 220, and so on. As the bias voltage is applied to the polarization switching segment, the state of polarization of the light incident to the switch may switch as well.

Control of each polarization switching element may be performed by a controller within projector 110, or from an external controller that may synchronize with source 105 and/or projector 110. The segmented polarization control segments 122, 123, 124, 125, 126 may be operable to selectively transform the state of polarization (SOP) of the modulated light incident from the projection lens 116 between orthogonal polarization states according to the polarization control instructions applied to each segmented polarization control segment. Although six segmented polarization control segments are shown here for illustrative purposes, it should be appreciated that the number of polarization switching segments may vary, and six are shown merely for illustrative and discussion purposes only.

In one example, a segmented polarization switch may present a frame sequence and may include a series of right eye content and left eye content. A blank set of image lines can be inserted in the frame sequence to provide a dark period. This dark period, which may be a fraction of the image frame cycle time, can be timed to substantially coincide with the polarization state switching of each segment of the segmented modulator. This approach may prevent blurring of the image as the polarization switches from one polarization state to another. Instead of blanking the entire image while a single polarizer switches state, the segmented polarization switch may blank a small section of the display while a small segment of the modulator switches state.

One aspect of the disclosure may include alignment of the segmented polarization switch with the image exiting the projector. This can be accomplished in many ways. In one example, the modulator opening may be approximately the same aspect ratio as the imaging device, which for cinema content may be approximately 1.9 to 1. Additionally, the modulator opening may be other aspect ratios depending on the content. In another example, the aspect ratio of the modulator opening may be approximately 1.8:1 for HD content. Returning to the example for cinema content and a 1.9:1 aspect ratio for the modulator opening, the entire imaging chip may fit tightly within the operating area of the segmented modulator. This may allow different sized content to be displayed while maintaining the correct timing between the segments of the display and the refreshing image, so long as the entire imaging chip is refreshed on every frame cycle.

The present disclosure provides for single LCD/LCOS projectors to present frame-sequential content for the first time. Frame-sequential presentation is desirable because it may allow a single projector to be used for 3D content. This may eliminate the alignment and optical balancing challenges of a dual projector system. It may also allow the entire imaging chip to be used, which may not be possible when left and right eye images are presented side-by-side on a single imager, which is another approach in current use.

To use this device, the LCD/LCOS imager may refresh fast enough that the human eye does not perceive flicker. For content that is recorded at approximately a nominal 30 fps, which is typical of broadcast content, a total of approximately 60 frames per second may be presented for a 3D presentation. This content may be double flashed resulting in approximately 120 refresh cycles per second.

For content that is recorded at approximately a nominal 24 frames per second, which is typical of motion picture content, a total of approximately 48 frames per second may be presented for a 3D presentation. This content at double flash may result in approximately 96 flashes per second, which may not be fast enough to eliminate the perception of flicker. The content can be triple flashed for a total of approximately 144 flashes per second, which is approximately 6.9 msec per frame cycle. Another option for approximately 24 fps content is to use an approximately 5:2 frame multiple which may effectively multiply by 2.5 flash. This may result in approximately 120 frames per second or approximately 8.33 msec per frame cycle. In general, it may be appropriate to use the highest frame rate multiple that the projector can accommodate.

The teachings of U.S. patent application Ser. No. 12/853,273, entitled “Improved segmented polarization control panel,” filed Aug. 9, 2010, which is herein incorporated by reference in its entirety, may be utilized to reduce potentially visible segment boundaries caused by the ‘dead’ regions between each polarization control segment.

### Scrolling Polarizing Direct-View Screen

A scrolling polarizing screen may be used in conjunction with direct-view LCD displays, as may be described in U.S. patent application Ser. Nos. 12/156,683 and 12/853,274, both of which are herein incorporated by reference.

In some cases, a scrolling polarizing screen may be a polarizing modulator and horizontal, vertical or any shape of strips of switching polarizer material may be used to switch individual segments of the polarizing modulator at a time. In such devices, each strip may be any type of polarizing switching material, including, but not limited to, an individual liquid crystal cell (LC cell), a pair of LC cells, pi-cells, FLC, TN cells, single or push pull TN or Pi-cells, STN, mechanical and so on.

In one example, as the LC modulation panel of a display refreshes the image from top to bottom, changing from left eye content to right eye content, the polarization of a corresponding part of a scrolling polarizing screen may change along with the display. It is possible with this technique for part of the display to present left eye content while the other part of the display presents right eye content. This is illustrated in FIG. 3, where the upper half of the display is in right eye mode and the lower half is in left eye mode.

This display may work with any content at any frame rate so long as the frame rate is fast enough to be viewed in a frame-sequential manner. Typically this frame rate should be more than the flicker fusion threshold of approximately 110 frames per second at theatrical brightness levels, or approximately 55 frames per eye, to reduce the perception of flicker. Flicker may be perceived with frame sequential projection at lower frame rates because each eye sees alternating light and black. Stated differently, while one eye is exposed with light, the other is seeing black.

As may be used herein, the terms “substantially” and “approximately” provide an industry-accepted tolerance for its corresponding term and/or relativity between items. Such an industry-accepted tolerance ranges from less than one percent to ten percent and corresponds to, but is not limited to, component values, angles, et cetera. Such relativity between items ranges between less than one percent to ten percent.

While various embodiments in accordance with the principles disclosed herein have been described above, it should be understood that they have been presented by way of example only, and not limitation. Thus, the breadth and scope of the embodiment(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A segmented polarization device for a projector comprising:
a segmented polarization modulator comprising a plurality of polarization switching elements operable to selectively transform the state of polarization of incident modulated light.

2. The segmented polarization device of claim 1, wherein the plurality of polarization switching elements further comprise strips of switching polarizer material.

3. The segmented polarization device of claim 2, wherein the strips of switching polarizer material are operable to switch individual strips of the segmented polarization modulator at a time.

4. The segmented polarization device of claim 2, wherein each of the strips of switching polarizer material are vertical strips and the plurality of polarization switching elements comprises one or more liquid crystal cells.

5. The segmented polarization device of claim 2, wherein the strips of switching polarizer material are operable to refresh an image on a display from the top to the bottom which may change the display from a first mode to a second mode.

6. The segmented polarization device of claim 5, wherein a first half of the display is in the first mode and a second half of the display is in the second mode.

7. The segmented polarization device of claim 2, wherein the strips of switching polarizer material are operable to selectively transform the state of polarization of incident modulated light.

8. The segmented polarization device of claim 7, wherein the state of polarization is transformed between substantially orthogonal polarization states.

9. The segmented polarization device of claim 1, wherein a voltage applied to the segmented polarization modulator modulates the state of polarization of incident light.

10. The segmented polarization device of claim 2, wherein the strips of the switching polarizer material are operable to switch polarization states, wherein the switching is timed to substantially coincide with a blank set of images lines on a display that provide a dark period in a frame sequence.

11. The segmented polarization device of claim 1, wherein the plurality of polarization switching elements are arranged in a quadrant pattern to form an optical window.

12. A method of stereoscopic projection, the method comprising:
operating a segmented polarization switch in a scrolling mode by sequentially switching individual polarization switching elements that are substantially synchronized with a frame sequence of a projector.

13. The method of claim 12, further comprising inserting a blank set of image lines in the frame sequence.

14. The method of claim 13, wherein inserting the blank set of image lines further comprises providing a dark period wherein the dark period is a fraction of an image frame cycle time.

15. The method of claim 14, further comprising timing the dark period to substantially coincide with the polarization state switching of each segment of a segmented modulator.

16. The method of claim 13, wherein inserting the blank set of images lines in the frame sequence further comprises blanking a small section of the display while a corresponding, aligned segment of a modulator switches polarization states.

17. A method for stereoscopic projection, the method comprising:
providing a segmented polarization modulator comprising a plurality of polarization switching elements operable to selectively transform the polarization state of incident light, wherein the segmented polarization modulator further comprises strips of switching polarization material operable to switch individual segments of a polarizing modulator.

18. The method for stereoscopic projection of claim 17, further comprising refreshing an image on a display from the top to the bottom and changing from a first mode to a second mode, wherein refreshing the image is coordinated with switching individual segments of the polarizing modulator.

19. The method for stereoscopic projection of claim 17, further comprising inserting a blank set of image lines in a frame sequence and timing the blank set of images lines to substantially coincide with the polarization state switching of each segment of a segmented modulator.

20. The method for stereoscopic projection of claim 18, further comprising transforming the state of polarization of the incident light passing through the segmented polarization modulator from a first polarization state to a second polarization state, wherein the second polarization state is substantially orthogonal to the first polarization state.
